(19) United States
(12) Patent Application Publication
(10) Pub. No.: US 2003/0205931 A1
(43) Pub. Date: Nov. 6, 2003

(54) Apparatus for determining positions and movements of a brake pedal for a vehicle brake system

(76) Inventors: Jens Hauke Muller, Kalt (DE); Boris Koeth, Sulzbach (DE); Laurenz Gruter, Heidelberg (DE); Karlheinz Schaust, Fachbach (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/447,640

(22) Filed: May 29, 2003

Related U.S. Application Data
(63) Continuation of application No. PCT/EP01/13943, filed on Nov. 29, 2001.

(30) Foreign Application Priority Data
Nov. 29, 2000 (DE) 100 59 128.0

(51) Int. Cl. B60T 13/66

(52) U.S. Cl. 303/20

(57) ABSTRACT

The present invention relates to an apparatus for determining a pedal displacement of a brake pedal for a vehicle brake system. In said case, a magnetic element disposed on a piston in the interior of a housing of a brake cylinder is used, which cooperates with a sensor element disposed at the outside of the brake cylinder in order to detect positions and movements of the piston. As positions and movements of the piston connected to the magnetic element correspond directly with positions and movements of a brake pedal connected rigidly and directly thereto or characterize said positions and movements in the case of an indirect connection to the brake pedal, it is possible on the basis of positions and movements, which are determined for the piston, to infer the underlying pedal displacement of the brake pedal.

### FIELD OF THE INVENTION

The present invention relates to an apparatus which makes it possible to determine positions and movements of actuating devices and, in particular, of brake pedals for vehicle brake systems. In particular, the present invention relates to an apparatus, by means of which positions and movements of pistons in brake cylinders for vehicle brake systems are detected in order to determine underlying positions and movements of corresponding actuating units and, in particular, of brake pedals.

### BACKGROUND OF THE INVENTION

For the operation of electrically or electronically controlled vehicle brake systems it may be necessary to detect positions and movements of a brake pedal which is either connected to, or serves as, an actuating device for the vehicle brake system. It is therefore known, in the case of anti-skid systems (ABS) and particularly in the case of ABS with unpressurized return of brake fluid to a compensation container, to use a sensor which detects the position of the brake pedal. Sensor output signals characterizing the brake pedal positions are used for control purposes during ABS feedback control and in particular for the control of used fluid pumps. In the case of so-called brake assists, which are mostly used in conjunction with electronically controlled vehicle brake systems and in critical driving situations are intended to guarantee maximum boosting of the braking force, displacement sensors are used to determine movements of brake pedals.

For the detection of positions and/or movements of brake pedals it is known to connect suitable position and/or displacement sensors to brake pedals or actuating rods coupled thereto. Furthermore, for said purpose sensors are used, which are connected to components in the interior of a brake cylinder (e.g. diaphragm/movable wall of a brake booster) which are movable in dependence upon positions and movements of a brake pedal. Such sensors conventionally take the form of mechanical potentiometers and are connected via a lead-in point in the housing of a brake cylinder to an appropriate one of the said movable components of the brake cylinder.

When for the detection of positions and movements of brake pedals use is made of sensors which are connected directly to a brake pedal, or to an actuating rod coupled thereto, of a vehicle brake system measuring inaccuracies may occur. One reason for their occurrence is that because of radial components of displacement of the brake pedals or of the actuating rod, mechanical deformation of said devices upon actuation by a vehicle driver and the like, the detected positions and movements for the brake pedals are not correctly determined. This is disadvantageous particularly in the case of electronically controlled vehicle brake systems because, there, use is made of the positions and movements of brake pedals to determine a braking operation desired by a vehicle driver and to generate braking forces accordingly.

The use of sensors, which, as mentioned above, are mechanically connected to movable components in the interior of brake cylinders, makes it necessary to provide suitable lead-in points in brake cylinder housings. Such lead-in points complicate the manufacture and maintenance of such vehicle brake systems. They also constitute an additional fault source because e.g. hydraulic fluid may escape through them.

### OBJECT OF THE INVENTION

The object of the invention is to provide a solution for accurately determining positions and movements of actuating devices and, in particular, of brake pedals for vehicle brake systems.

### BRIEF DESCRIPTION OF THE INVENTION

The present invention is based on the approach of detecting positions and movements of a piston in a brake cylinder of a vehicle brake system and, on the basis of the detected positions and movements, determining underlying positions and movements of a corresponding actuating device and, in particular, of a brake pedal. In said manner, desired actuations of the vehicle brake system by a vehicle driver, i.e. positionings and movements of pistons of the brake cylinders, are determined more accurately because for said purpose the actual positioning or movement of a piston is detected. A further advantage of said procedure is that the braking forces provided by a vehicle brake system and, in particular, existing pressures in hydraulic chambers of said system may easily be determined. As the effective area of a piston cooperating with a hydraulic fluid in a brake cylinder is defined, it is possible with knowledge of said parameter in conjunction with determined positions and movements of the piston to determine the currently existing pressure in the hydraulic chamber and hence the provided brake pressure.

In particular, the present invention provides an apparatus for determining positions and movements of an actuating device for a vehicle brake system. The apparatus according to the invention comprises a primary detector, which is to be disposed in an interior of a brake cylinder of a vehicle brake system so as to be positionable and movable in dependence upon positions and movements of an actuating device for the vehicle brake system. Said apparatus further comprises a sensor device, which is constructed separately from the primary detector and fitted outside of the brake cylinder, e.g. to an outer surface thereof, in order to detect position and movements of the primary detector. detector. As the primary detector is positionable and actuable in dependence upon positions and movements of the actuating device, positions and movements of the actuating device are determined in said manner. The primary detector is preferably disposed directly on a piston of the brake cylinder.

In an embodiment of the present invention, the primary detector comprises components generating magnetic fields, which are detected by the sensor device. In said case, it is provided that the primary detector is annular or disk-shaped for fitting e.g. i on an end face of the piston. It is moreover also possible to use other types of primary detector, which in combination with appropriate sensor devices produce electric and/or magnetic signals which are suitable for the detection of positions and movements. In said case it is possible to use active primary detectors, which themselves generate and produce suitable signals, or passive primary detectors which, for example, having been externally activated (e.g. by an appropriate sensor sensor device) produce signals such as e.g. inductively generated electromagnetic fields.

The present invention further provides a brake cylinder for a vehicle brake system, which in a conventional manner comprises a housing as well as a piston movably disposed in the interior of the housing. According to the invention the brake cylinder comprises a primary detector, which is disposed in a fixed manner on the piston, and a sensor device, which is disposed preferably in a fixed manner outside of the housing, e.g. at an outer surface thereof, in order to detect positions and movements of the primary detector.

Positions and movements of the primary detector are preferably determined by means of magnetic fields, wherein the primary detector comprises suitable magnetic elements and the sensor device is designed to detect the generated magnetic fields. As mentioned above, other types of primary detector and sensor device may also be used.

The primary detector may be annular or disk-shaped, wherein it is preferred that the primary detector be disposed on an end face of the piston. For the fixed arrangement of the primary detector relative to the piston, a spring element and/or a clamping element may be used. Said procedure makes it possible to use available pistons without the latter having to be substantially modified for the arrangement of the primary detector. Alternatively or additionally, the primary detector may also be fastened to the piston by means of an adhesive joint.

Given use of the spring element for positioning the primary detector relative to the piston, simultaneous use is preferably made of a spring element, which is used in the brake cylinder and, as an element generating restoring forces, cooperates with the piston.

When, for example, use is made of a piston which in axial direction has a T-shaped cross section, it is possible to arrange the primary detector in a region of smaller diameter of the piston. To achieve a desired measuring accuracy, it is necessary to comply with a corresponding accuracy of arrangement of the sensor device relative to a preset position of the primary detector. The preset position for the primary detector may be, for example, the position it occupies when the brake cylinder is not actuated or is fully actuated. In said case, the appropriate arrangement of the sensor device may be simplified when the housing comprises devices, which are used to arrange the sensor device at a position preselected for the latter.

A calibrating device may moreover be used to determine in dependence upon positions and/or movements of the primary detector the position of the latter relative to the sensor device. The sensor device may then be calibrated and/or its positioning may be checked with the calibrating device.

For transmitting positions and movements of the primary detector detected by the sensor device to e.g. a control device for the brake cylinder, a vehicle brake system comprising the brake cylinder and/or other control devices for operation of the motor vehicle (e.g. ABS, brake assist, vehicle dynamics controller), the sensor device may comprise an interface, which relays corresponding signals produced by the sensor device.

It is moreover provided that in a vehicle brake system with two brake circuits an apparatus according to the invention is assigned to each one of the brake circuits in order to detect positions and movements of the actuating device effective for the individual brake circuits.

In particular in vehicle brake systems with two brake circuits having a first piston for one brake circuit and a second piston for the other brake circuit primary detectors may be arranged on the first piston and on the second piston. Accordingly, sensor devices may be associated with the primary detectors arranged on the first and the second piston, which sensor devices may be arranged e.g. on appropriated areas of outer surfaces of the brake cylinder or the brake cylinders, which the first and second pistons, respectively, has/have.

In addition, the apparatus may comprise means detecting an actuation of the actuating device, e.g. the start of a movement or the leaving of a non-actuated position of the actuating device.

The actuation detection means preferably generates signals that are used directly or indirectly, for example by using control units for the actuator, or an engine control unit (ECU), in order to bring the apparatus from a rest state in which no positions and movements of the actuating device are detected into an operating state in which positions and movements of the actuating device are detected. This “wake-up” of the device makes it possible to operate the apparatus only, i.e. to provide it with the required operating energy, when it is actually necessary to detect positions and movements of the actuating device. The apparatus may be switched off completely in the rest state, i.e. it does not receive any energy, or it may be operated in the so-called stand-by mode which, compared to the operative state, requires reduced energy supply. It is possible in this manner to reduce the energy consumption of the apparatus and hence of the vehicle brake system and the vehicle.

In addition, it is provided that the signals generated by the actuation detection means are used to activate stop lamps of the vehicle in response to an actuation of the actuating device of the vehicle brake system. This has the advantage that the vehicle stop lamps are only activated when the vehicle braking system is actually actuated since conventional stop lamp switches generally respond to operations of the brake pedals which, due to tolerances and play of the brake pedal mechanisms, do not necessarily result in an actual activation of the vehicle brake system.

It is also provided that the actuation detection means comprises a so-called reed switch operable by the primary detector.

The actuation detection means is preferably of uniform construction with the sensor device.

In vehicle brake systems with two brake circuits an actuation detection means may be assigned to each one of the brake circuits, wherein the embodiment of the apparatus according to the invention may be used in which primary detector and sensor device are provided for the first and the second piston. Alternatively, the actuation detection means may be used with the embodiment of the inventive apparatus with a primary detector and a sensor device; here a “wake-up” can take place in response to an actuation of the first or second piston or if both pistons are moved from their rest positions.

The present invention moreover provides a vehicle brake system, which comprises a brake cylinder according to the invention and a control device, which is used to control the operation of the vehicle brake system at least partially in dependence upon detected positions and movements of the primary detector.

The vehicle brake system preferably comprises a simulating device, which in dependence upon detected positions and movements of the primary detector conveys to a vehicle driver upon actuation of a brake pedal the usual pedal characteristic of a conventional brake system, i.e. simulates the behavior of the brake pedal.

### BRIEF DESCRIPTION OF THE DRAWINGS

In the following description of preferred embodiments reference is made to the accompanying drawings, which show:

FIG. 1 a diagrammatic view of a tandem master cylinder for a vehicle hydraulic brake system with an embodiment of the apparatus according to the invention,

FIG. 2 diagrammatic views of embodiments of primary detectors for the apparatus according to the invention of FIG. 1,

FIG. 3 a diagrammatic view of a tandem master cylinder for an electronically controlled vehicle hydraulic brake system with the embodiment of FIG. 1,

FIG. 4 a diagrammatic view of a cylinder for a vehicle brake system with a further embodiment of the apparatus according to the invention.

FIGS. 4 to 7 diagrammatic views of the embodiments of the apparatus of the invention according to FIGS. 1, 3, and 4 with a means for detecting actuations of the actuating device.

### DESCRIPTION OF PREFERRED EMBODIMENTS

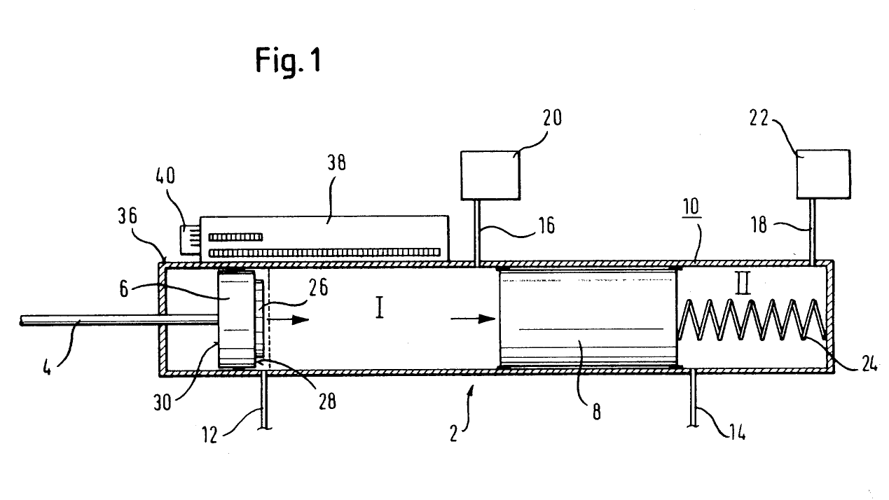

FIG. 1 shows a tandem master cylinder 2 for a vehicle hydraulic brake system. The master cylinder 2 is actuable via an actuating member 4, which is connected rigidly and directly to a first piston 6 disposed in the master cylinder 2. The actuating member 4, for its actuation, is connected directly or via an intermediate brake booster to a brake pedal. The first piston 6 together with a second piston 8 disposed in the master cylinder 2 and suitable inner surfaces (not designated) of a housing 10 of the master cylinder 2 delimits first and second hydraulic chambers I and II. The 'hydraulic chambers I and II contain hydraulic fluid, which may flow in or flow off via associated supply connections 12 and 14.

The hydraulic chambers I and II are connected by fluid lines 16 and 18 to wheel brakes 20 and 22 in order to supply the latter with hydraulic fluid in dependence upon an actuation of the master cylinder 2. A spring 24 cooperates with the second piston 8 in order to position the latter in the master cylinder 2 in dependence upon an actuation of the actuating member 4. The spring 24 moreover moves the second piston 8 and, via the fluid connection in the first hydraulic chamber I, the first piston 6 into their neutral positions when the master 5 cylinder 2 is not actuated.

As the first piston 6 is connected directly and rigidly to the actuating member 4, a displacement of the first piston 6 corresponds directly to a corresponding movement of the actuating member 4 and therefore characterizes the actuation of the brake pedal, more precisely the pedal displacement, effected by a vehicle driver.

In said case, a movement of the first piston 6 corresponds directly to the underlying pedal displacement when the brake pedal is directly connected to the actuating member 4. When a brake booster disposed between the actuating member 4 and the brake pedal is used, its parameters have to be taken into account in order to determine from a displacement of the first piston 6 the corresponding pedal displacement.

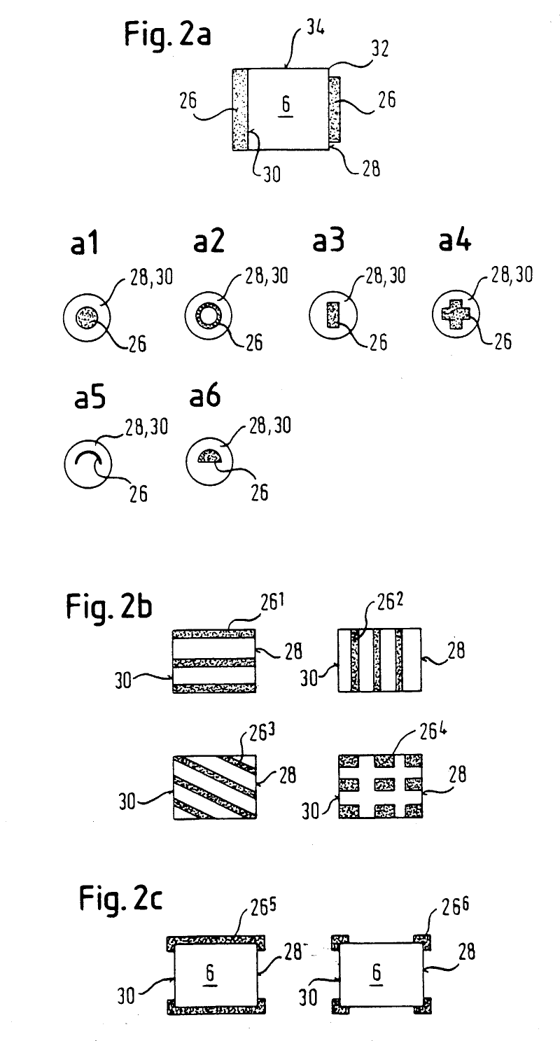

In order to determine the pedal displacement from a resulting displacement of the first piston 6 upon an actuation of the brake pedal, use is made of a primary detector 26, which is fitted in a fixed manner on the first piston 6. The primary detector 26 illustrated in FIG. 1 is disposed on an end face 28 of the first piston 6 facing the first hydraulic chamber I; the primary detector 26 may also be fastened to an opposite end face 30. Further possible arrangements of individual or multiple components, which fulfill the function of the primary detector 26, on the first piston 6 are shown in FIG. 2. In the construction shown in FIG. 2a the primary detector 26 may be disposed on the end face 28 and/or the end face 30, FIGS. 2a1 to a6 illustrating a selection of possible shapes of the primary detector 26. In said case, care is to be take to ensure that the primary detector 26 may completely cover the end face 28 and/or the end face 30 or extend up to an edge 32 formed with an—in axial direction of the first piston 6—outer peripheral surface 34. In the constructions shown in FIGS. 2b and 2c, the primary detector 26 may comprise individual or a plurality (e.g. 2, 4, 5, . . . ) of primary detector components 26¹ to 26⁶ and! combinations thereof.

Disposed at an outer surface 36 of the housing 10 of the master cylinder 2 is a sensor device 38, which cooperates with the primary detector 26 in order to determine positions and movements of the first piston 6. In dependence upon positions and movements of the primary detector 26 and hence of the first piston 6 the sensor device produces corresponding signals, which relay via a signal interface 40 to components (not shown here), which use said signals to control the operation of the motor vehicle and, in particular, to control the vehicle brake system. The interface 40 is advantageously a bidirectional interface in order to control and monitor the sensor device 38, e.g. by means of a vehicle management system.

The arrangement of the primary detector 26 inside the housing 10 and of the sensor device 38 outside of the housing 10 simplifies the construction of the master cylinder 2 because it eliminates the need for connections between the primary detector 26 and the sensor device 38, which have to be passed through the housing 10. Said arrangement moreover allows the use of master cylinders 2 which are already available and which merely require slight modification. This involves making provision for a fixed arrangement of the sensor device 38 on the housing exterior, which may be effected e.g. by screw fastening, gluing etc. It is equally possible to use available pistons for the first piston 6 in that one or more components serving as primary detector 26 are used, which do not substantially alter the technical characteristics of the first piston 6. This is the case, for example, when a component serving as primary detector 26 is used, which has small dimensions that do not substantially influence the volume of the first hydraulic chamber I and which is fitted by means of a suitable adhesive joint on the first piston 6.

As primary detector 26 and sensor device 38 it is possible to use any components which are capable of using electrical and/or magnetic signals to detect positions and movements of the first piston 6 without any physical connection (e.g. cable, line) between the primary detector 26 and the sensor device 38. The arrangement and/or shape of the primary detector 26 (see FIG. 2) results from the nature of the used sensor device 38 and of the primary detector 26, of the used master cylinder 2, from the accuracy with which positions and movements of the first piston 6 are to be determined, and the like.

In the embodiment shown in FIG. 1, the primary detector 26 is an annular or disk-shaped magnetic element. Its magnetic field, more precisely positions and movements of the magnetic field, are detected by the sensor device 38 in order to determine the pedal displacement responsible for an actuation of the master cylinder 2.

Given the use of a magnetic element for the primary detector 26, it is necessary for reliable detection of its positions and movements to use a master cylinder 2, the material(s) of which do not corrupt or influence the magnetic field of the primary detector 26 in such a way that the desired measuring accuracy of the sensor device 38 is impaired. For example, the housing of the master cylinder 2 may be made of the non-magnetic material aluminum, thereby offering additional advantages in terms of weight.

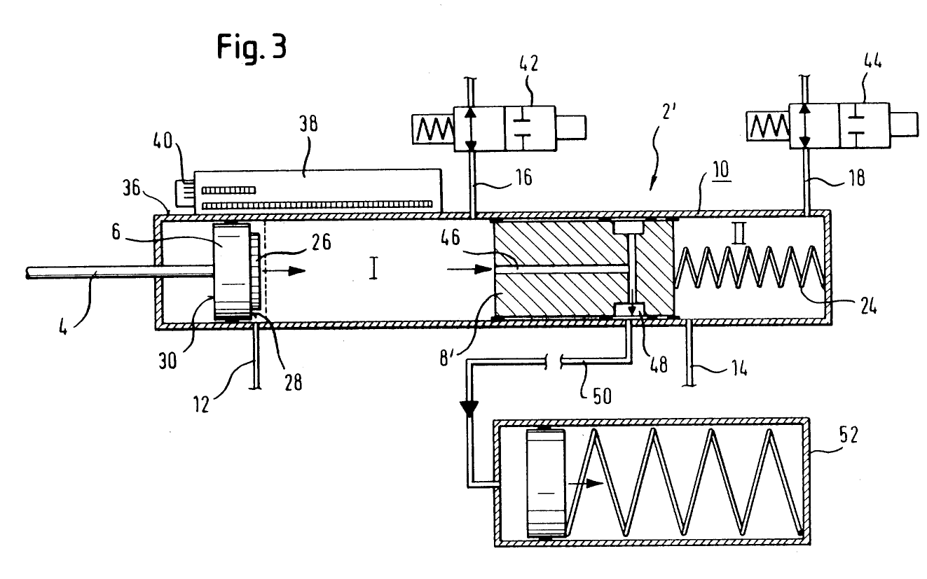

In the master cylinder for an electronically controlled vehicle hydraulic brake system shown in FIG. 3, components corresponding to components of the embodiment shown in FIG. 1 are provided with identical reference characters. As the master cylinder 2′ shown in FIG. 3 is known from the German patent having the number 199 50 862, a more detailed description is not given here.

The master cylinder 2′ is connected by the fluid lines 16 and 18 to valve devices 42 and 44, the function and operation of which are described in the cited patent. Instead of the second piston 8, in said embodiment a second piston 8′, which in a known manner comprises a channel 46 and an outlet 48, is used in order to cooperate via a fluid connection 50 with a simulating device 52. The simulating device 52 is used to convey to a driver, upon an actuation of a brake pedal connected (in)directly to the actuating member 4, the usual pedal characteristic of a conventional brake system.

Through the use of the sensor device 38 in conjunction with the primary detector 26, the simulating device 52 and in particular a known characteristic-modeling device (not shown here) connected thereto for simulating a brake pedal characteristic may be supplemented or replaced in the sense that the positions and movements of the first piston 6, which are detected by the sensor device 38, are (simultaneously) used to determine a desired pedal characteristic. If the characteristic-modeling device is to be replaced in said manner, it is then possible on the basis of a thus determined pedal characteristic to effect corresponding control of, for example, an electromechanical actuator which cooperates with the brake pedal. In said case, the simulating device 52 may be replaced by a hydraulic fluid reservoir, which either receives or discharges hydraulic fluid via the fluid connection 50 in dependence upon an actuation of the master cylinder 2′.

In not illustrated embodiments of the arrangements shown in FIGS. 1 and 3, primary detectors are also arranged on the second pistons 8 and 8′, respectively, which cooperate with the associated sensor devices arranged on the outer sides of the master cylinders 2 and 2′, respectively. These arrangements make it possible to detect positions and movements of the first and second pistons 6 and 8 separately in order to use, as described above, corresponding signals for controlling the operation of the motor vehicle and especially for controlling the vehicle brake system. The advantage is that the actually occurring positions and movements of the first and second pistons 6 and 7 or 8′ are detected in response to an actuation of the actuator device 4 to ensure an optimized control especially of the vehicle brake system. It is also possible in this manner to detect faulty operating states of a vehicle brake system if, during an actuation of the actuator device 4, for example, one or both pistons 6 and 8 or 8′ does/do not assume corresponding positions to be expected and/or perform movements.

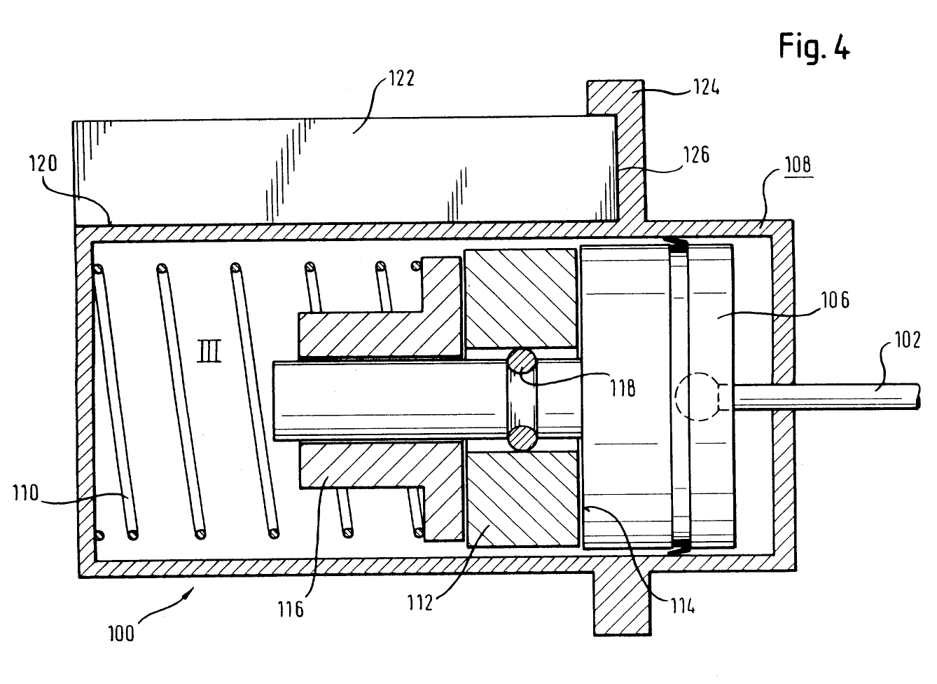

The cylinder 100 diagrammatically illustrated in FIG. 4 may be either a master cylinder connected to a brake booster or a cylinder of a brake booster. As mentioned above, the cylinder 100 is actuated via an actuating member 102, which is connected rigidly and directly to a piston 106. The piston 106 is disposed in the interior of a housing 108 of the cylinder 100 and cooperates with a spring element 110, which fulfils the previously described functions of the spring 24. The piston 106 in axial direction has a substantially T-shaped cross section. A primary detector 112 in the form of an annular magnetic element is held in a fixed manner relative to the piston 106 between an end face 114 of the piston 106 and a clamping element 116. The clamping element 116 is disposed at the region of smaller diameter of the piston 106. The fixed arrangement of the primary detector 112 and of the clamping element 116 on the piston 106 is achieved here by means of the spring element 110 but may be improved by connecting the clamping element 116 in a fixed manner, e.g. by pressing and/or gluing, to the piston 106. It is likewise provided that the primary detector 112 be connected in a fixed manner to the piston 106. Irrespective of the arrangement of the primary detector 112 on the piston 106, it is possible, as FIG. 4 reveals, to use an annular element in order to compensate tolerances between the primary detector 112 and the piston 106, with the result that manufacturing costs arising from manufacturing tolerance compliance are minimized.

In an embodiment, which is not illustrated, the clamping element 116 is not used and the primary detector 112 is contacted by the spring element 110. In said case, the primary detector 112 may have the shape illustrated in FIG. 4 or the shape shown there for the clamping element 116.

Disposed in a fixed manner on an outer surface 120 of the housing 108 is a sensor element 122 which, in the manner described above, cooperates with the primary detector 112 in order to detect positions and movements of the piston 106. For the fixed arrangement of the sensor element 122, a fastening flange 124 of the housing 108 has a stop 126. The positioning of the stop 126 is to be defined in dependence upon the size of the sensor element and upon possible positions and movements of the piston 106 in order to guarantee reliable determination of the pedal displacement.

In order to save energy when operating a vehicle, it is of advantage to only put components and especially electrically or electronically controlled devices into an operative state, i.e. to supply it with appropriate energy, when they are actually required. Accordingly, it is of advantage for such components and devices to be in a rest state or a so-called stand-by mode when they are not required. In connection with vehicle brake systems stop lamps are normally used to this end which are responsive to brake pedal actuations. However, stop lamp switches supply inexact signals, i.e. signals indicating an actuation of brake pedals but not necessarily characterizing an actual operation of the respective vehicle brake system since, due to tolerances and play of brake pedals, an actuation of the same need not necessarily result in an actual activation of the vehicle brake system. Accordingly, the use of stop lamp switches for the “wake-up” of an apparatus according to the invention can result in it being brought from a rest state with low or no energy consumption into an operating state although there is no actual operation of the vehicle brake system.

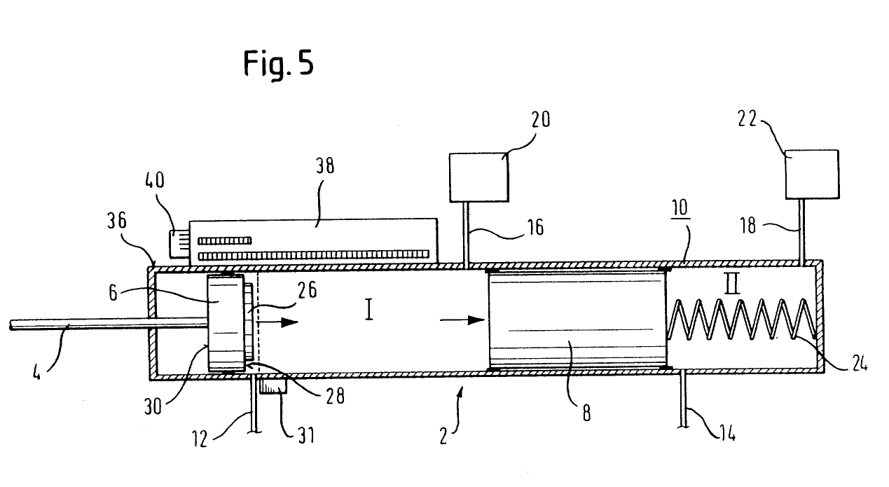

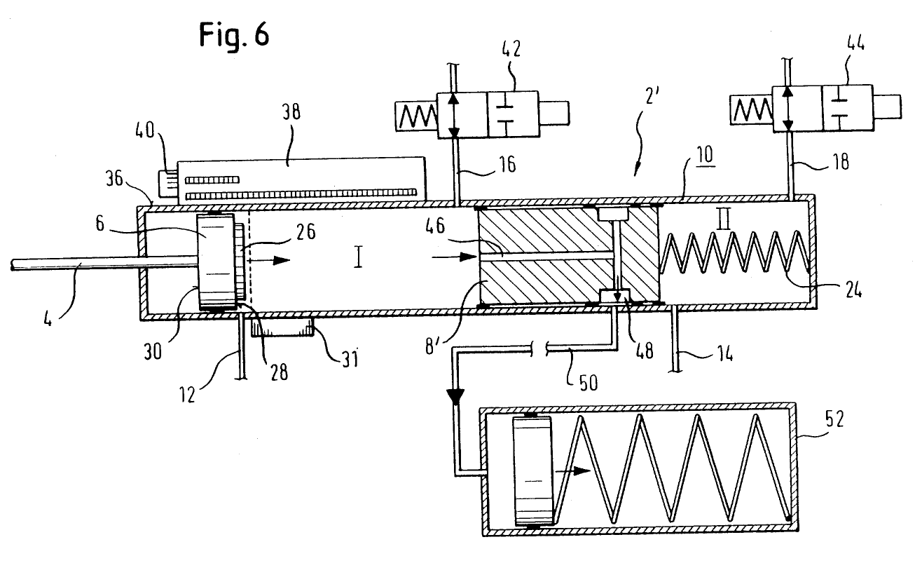

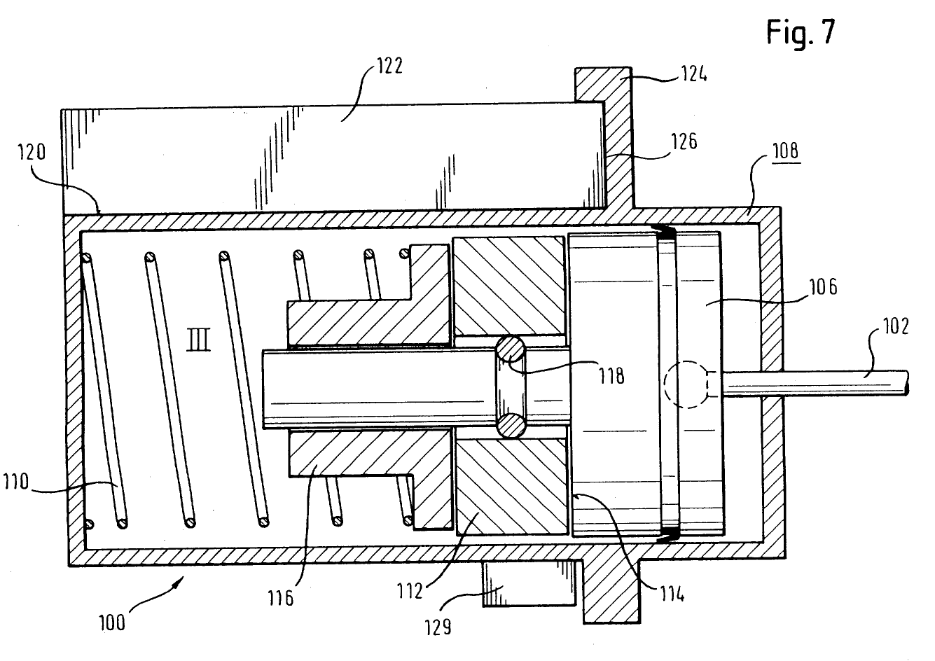

The constructions shown in FIGS. 5, 6 and 7 of the embodiments of FIGS. 1, 3 or 4 can be used to solve this problem. There means 31 and 129, respectively, are provided which are responsive to the primary detectors 26 and 112, respectively. If the pistons 26 and 106, respectively, are moved by an actuation of actuator devices 4 and 102, respectively, from the rest positions illustrated in FIGS. 5, 6 and 7, primary detector 26 and 112, respectively, cooperates with means 39 and 129, respectively, such that it generates signals to “wake up” at least sensor device 38 and 122, respectively, and components preferably used in conjunction therewith, i.e. sets them from a stand-by mode into an operating state.

Reed switches, for example, may be used as means 39 and 129 which detect the start of a movement of the sensor devices 26 and 112 from their rest position. In addition, it is provided that the signals generated by means 31 and 129 are also used to activate vehicle stop lamps.

When using reed switches for means 31 and 129, an actuation of the actuating devices 4 and 102 causes a movement of the primary detectors 26 and 112 from their rest position which activates the reed switch. In the not actuated state of the vehicle brake system, the reed switch may be open and closed by a movement of the respective primary detector 26 and 112, respectively. Current flowing through the closed reed switch may then be used to wake up the apparatus according to the invention. Alternatively it is provided that the reed switch is closed when the vehicle brake system is not actuated. In order to keep energy consumption as low as possible, the reed switch may be connected with a semiconductor element, e.g. a FET, which requires less energy and “wakes up” the apparatus according to the invention as the reed switch is opened in response to an actuation of the vehicle brake system.

In a construction of the apparatus according to the invention with primary detectors and sensor devices for a vehicle brake system with two brake circuits it is provided that to each one of the brake circuits are assigned means 31 and 129, respectively, e.g. in the form of reed switches.

1. Apparatus for determining positions and movements of an actuating device (4, 102) for a vehicle brake system, comprising:
a primary detector (26, 112), which is to be disposed in an interior (I, III) of a brake cylinder (2, 2′, 100) of a vehicle brake system so as to be movable in dependence upon movements of an actuating device (4, 102), and
a separately constructed sensor device (38, 122) to be disposed outside of the brake cylinder (2, 2′, 100) for the detection of positions and movements of the primary detector (26, 112),
characterized by
the sensor device (38, 122) for detecting movements of the primary detector (26, 112).

2. Apparatus according to claim 1, characterized in that the primary detector (26, 112) is designed for arrangement on a piston (6, 106) of the brake cylinder (2, 2′, 100).

3. Apparatus according to claim 1 or 2, characterized in that
the primary detector (26, 112) comprises magnetic elements for generating magnetic fields, and
the sensor device (38, 122) is designed for the detection of positions and movements for the primary detector (26, 112) through detection of the magnetic fields.

4. Apparatus according to one of the preceding claims, characterized in that the primary detector (26, 112) for arrangement in the interior (I, II) of the brake cylinder (2, 2′, 100) is annular or disk-shaped.

5. Apparatus according to one of the preceding claims, characterized in that the sensor device (38, 122) is fitted on an outer surface (36, 120) of the brake cylinder (2, 2′, 100).

6. Apparatus according to one of the preceding claims,
characterized in that
the sensor device (38, 122) comprises an interface (40) for the transmission of signals which characterize detected positions and movements of the primary detector (26, 112)

7. Apparatus according to one of the preceding claims, characterized by means (31, 129) for detecting the start of an actuation of the actuating device (4, 102).

8. Apparatus according to claim 7, characterized by the actuation detection means (31, 129) for generating signals to bring the apparatus from a rest state in which no positions and movements of the actuating device (4, 102) are detected into an operating state in which positions and movements of the actuating device (4, 102) are detected.

9. Apparatus according to claim 7 or 8, characterized in that the actuation detection means (31, 129) comprises a reed switch operable by the primary detector (26, 112).

10. Brake cylinder for a vehicle brake system, comprising:
a housing (10, 108), and
a piston (6, 106), which is disposed movably in the interior of the housing (10, 108),
characterized by
a primary detector (26, 112), which is disposed in a fixed manner relative to the piston (6, 106), and
a sensor device (38, 122), which for detecting positions and movements of the primary detector (26, 112) is disposed outside of the housing (10, 108),
characterized by
the sensor device (38, 122) for detecting movements of the primary detector (26, 112).

11. Brake cylinder according to claim 10, characterized in that
the primary detector (26, 112) comprises magnetic elements for generating magnetic fields by the sensor device (38, 122), and
the sensor device (38, 122) is designed for the detection of positions and movements of the primary detector (26, 112) through detection of the magnetic fields.

12. Brake cylinder according to claim 10 or 11, characterized in that the primary detector (26, 112) is annular or disk shaped.

13. Brake cylinder according to one of claims 10 to 12,
characterized in that
the primary detector (26, 112) is fitted on an end face (28, 30) of the piston (6, 106).

14. Brake cylinder according to one of claims 10 to 13,
characterized in that
the sensor device (38, 122) is fitted on an outer surface (36, 120) of the housing (10, 108).

15. Brake cylinder according to one of claims 10 to 14, characterized in that the piston (6, 106) in axial direction has a T-shaped cross section, and
the primary detector (26, 112) is disposed in a region of smaller diameter of the piston (6, 106).

16. Brake cylinder according to one of claims 10 to 15, characterized in that the primary detector (26, 112) is held in a fixed manner relative to the piston (6, 106) by a spring element (110).

17. Brake cylinder according to one of claims 10 to 16, characterized in that the primary detector (26, 112) is held in a fixed manner relative to the piston (6, 106) by a clamping element (116).

18. Brake cylinder according to one of claims 10 to 17, characterized in that the housing (10, 108) comprises devices (124, 126) for the arrangement of the sensor device (38, 122) at a preset position.

19. Brake cylinder according to one of claims 10 to 18,
characterized in that
the sensor device (38, 122) comprises an interface (40) for the transmission of signals which characterize detected positions and movements of the primary detector (26, 112).

20. Brake cylinder according to one of claims 10 to 19, characterized by means (31, 129) for detecting the start of a movement of the primary detector (26, 112).

21. Brake cylinder according to claim 20, characterized by the actuation detection means for generating signals to bring the sensor device (38, 122) from a rest state in which no positions and movements of the primary detector (26, 112) are detected into an operating state in which positions and movements of the primary detector (26, 112) are detected.

22. Brake cylinder according to claim 20 or 21, characterized in that the actuation detection means (31, 129) comprises a reed switch operable by the primary detector (26, 112).

23. Vehicle brake system, comprising:
the brake cylinder according to one of claims 10 to 22, and
a control device for controlling the operation of the vehicle brake system in dependence upon detected positions and movements of the primary detector (26, 112).

24. Vehicle brake system according to claim 23, characterized by a simulating device for simulating a brake pedal behavior of a brake pedal for the vehicle brake system in dependence upon detected positions and movements of the primary detector (26, 112).
